(19) United States
(12) Patent Application Publication
(10) Pub. No.: US 2011/0169953 A1
(43) Pub. Date: Jul. 14, 2011

(54) Super resolution imaging sensor

(75) Inventors: David Sandler, San Diego, CA (US); Mikhail Belenkii, San Diego, CA (US); Todd Barrett, San Diego, CA (US)

(73) Assignee: Trex Enterprises Corp.

(21) Appl. No.: 12/657,187

(22) Filed: Jan. 14, 2010

(51) Int. Cl. H04N 7/18; G06K 9/40

(52) U.S. Cl. 348/144; 382/275; 348/E07.085

(57) ABSTRACT

A system and process for converting a series of short-exposure, small-FOV zoom images to pristine, high-resolution images, of a face, license plate, or other targets of interest, within a fraction of a second. The invention takes advantage or the fact that some regions in a telescope field of view can be super-resolved; that is, features will appear in random regions which have resolution better than the diffraction limit of the telescope. This effect arises because the turbulent layer in the near-field of the object can act as a lens, focusing rays ordinarily outside the diffraction-limited cone into the distorted image. The physical effect often appears as magnified sub-regions of the image, as if one had held up a magnifying glass to a portion of the image. Applicants have experimentally shown these effects on short-range anisoplanatic imagery, along a horizontal path over the desert. In addition, they have developed powerful parallel processing software to overcome the warping and produce sharp images.

### FIELD OF THE INVENTION

This invention relates to sensor and in particular to high resolution imaging sensors.

### BACKGROUND OF THE INVENTION

Various techniques for increasing the resolution of through the atmosphere imaging systems without increasing the size of the aperture of the imaging system are well known. Several are discussed in the attached document. There is a desire for systems that can be utilized in an aircraft to image people at distances of in the range of 30 to 50 km. The theory and successful performance of image processing and adaptive optics methods is well known, for space surveillance, looking up through the atmosphere at long range. In this case, the target acts essentially like a point source, the turbulence is in the far field of the target, and recovery of a single atmospherically induced wavefront suffices to correct the image distortion (“isoplanatic imaging”). However, only in recent years has the theory of imaging larger objects embedded in strong near-field turbulence been advanced. The behavior of image distortion, and its correction, are much different for this “anisoplanatic” case. Each point on the object suffers different atmospheric distortion, and the resultant imagery can be severely warped. Sophisticated algorithms have been developed to remove the warping. Further, theory and experimental data have recently shown that in a short exposure of the scene, random instantaneous portions of the image can appear very sharp (“lucky region”). Astronomers have used lucky short exposures to obtain very sharp images, for isoplanatic imaging. For anisoplanatic imaging, lucky exposures are relatively rare, but the appearance of sharp regions of the image is fairly common.

### SUMMARY OF THE INVENTION

The present invention a system and process for converting a series of short-exposure, small-FOV zoom images to pristine, high-resolution images, of a face, license plate, or other targets of interest, within a fraction of a second. The invention takes advantage or the fact that some regions in a telescope field of view can be super-resolved; that is, features will appear in random regions which have resolution better than the diffraction limit of the telescope. This effect arises because the turbulent layer in the near-field of the object can act as a lens, focusing rays ordinarily outside the diffraction-limited cone into the distorted image. The physical effect often appears as magnified sub-regions of the image, as if one had held up a magnifying glass to a portion of the image. Applicants have experimentally shown these effects on short-range anisoplanatic imagery, along a horizontal path over the desert. In addition, they have developed powerful parallel processing software to overcome the warping and produce sharp images.

Applicants' concept focuses on removing the turbulence effects on narrow FOV imagery, by real-time processing of a series of short-exposures of the FOV. This alone will produce sharp images of 6 cm resolution at a range of 30 km. But to achieve a goal of 1 inch resolution, required for accurate identification of human faces and license plates, for example, Applicants employ innovative, advanced image processing techniques for imaging through strong turbulence, to obtain super-resolved imagery, at 2× the diffraction limit. They enable a UAV to obtain visible imagery equivalent in resolution to a D=60 cm gimbal, looking through non-turbulent air. Since a 60 cm gimbal is beyond the size and weight restrictions for current UAV's, Applicants' provide the benefits of a larger gimbal, through a software-based solution.

### DETAILED DESCRIPTION OF PREFERRED EMBODIMENTS

In preferred embodiments an imaging system looks down through weak high-altitude turbulence in near-field of the sensor, but records light that has been bent and distorted by strong turbulence in the near-field of the object, which amplifies the physics effects referred to above. In addition, the scale size of the sub-regions is quite different. In the horizontal, short-range case, almost the entire FOV was a single face, and the goal was to piece together sections of the face. In the proposed program, the sub-regions are roughly the size of a face. So the lucky regions will correspond to 1 ft patches of the image at very high resolution.

These preferred embodiments are designed for an image resolution of 1 inch, at a range R=30 km with imaging systems of moderate size (i.e. 20-30 cm apertures). Applicants' understanding, based on publicly available information, is that current imagery can only distinguish human figures from the environment, and gross features of the body and clothes, which corresponds to 20-30 cm resolution. Thus, the new system will produce an order-of-magnitude improvement over the state of the art. The over-riding innovation is in exploiting the effect of strong atmospheric turbulence, which is normally a deteriorating influence on system performance, to extreme advantage.

### Example Application

As an example of an application of the present invention, a 30 cm diameter gimbaled telescope mounted on a Predator-type UAV is viewing a scene, in this case shown as a small group of humans. The limiting optical resolution of the gimbal is λ/D=2 μrad, where λ=0.6 μm is the center of the visible spectral region. To achieve this image resolution, the angular pixel size must be 1 μrad, for Nyquist sampling, corresponding to a “zoom” FOV in high-res mode of 1 mrad. At range R=30 km, this corresponds to 6 cm resolution at FOV=3 m, not sufficient for detailed face feature recognition, but very close, and usable for a wide region of ISR observations. If the resolution could be doubled, the capabilities would increase enormously, since a human eye is about 1 inch wide, and a license plate numeral is about 2-3 inches. However, to achieve this resolution, even under optimal conditions, would require a >60 cm gimbal, which according to current size/weight requirements is untenable for Predator-type UAV's. The question we address in the proposed program is thus: how do we achieve this equivalent resolution, using only software and a fast-frame sensor?

Applicants apply novel, yet both theoretically and experimentally verified, properties of images obtained through turbulence. It is well known and has been verified that the limiting resolution of a telescope when viewed through the earth's turbulence is λ/r₀, where r₀ is the size of the coherent phase patch in the presence of the distorting effects of turbulence and λ is the wavelength. The coherence length r₀ depends strongly on location/altitude above sea-level, time of day, and season of the year. In addition, it is much larger (turbulence is weaker) looking up through the atmosphere, than looking horizontally near the ground. This is because the index-of-refraction fluctuations which give rise to turbulent image distortion drop almost exponentially, as a function of distance above the earth's surface. For imaging looking upward at night-time on a mountain (an astronomical site), r₀ typically is >10 cm at visible wavelengths. For imaging during hot daytime conditions along a 1-2 km horizontal path, r₀ is typically around 1 cm. For D/r₀=1, turbulence is not a problem for imaging systems. As D/r₀ increases, the images acquired through turbulence become smeared, and then blurred, and eventually very distorted and broken up. Numerous image processing methods (speckle, deconvolution), as well as dynamic opto-mechanical methods (adaptive optics) have been developed to deal with this problem. These methods have been very successful for ISR applications, which involve looking up through the atmosphere at an object with small angular extent, like a 3-5 μrad satellite.

However, for imaging objects of >100 grad along extended paths near the earth's surface, these techniques are not applicable. This is because the angular region in object space over which the propagating light sees a single associated wavefront is very small. The result is that when viewing finite objects from ranges R<100 km, another type of distortion is present, which is crucial to our current proposal program. This distortion is called anisoplanatism, which means that different points of the imaging target, separated by more than the isoplanatic angle, q₀, have different wavefronts arriving at the imaging plane. Effectively, the image is broken up into regions of common wavefront, so that conventional methods that recover a single wavefront over the entire receiving aperture are no longer applicable. The optical physics of anisoplanatic imaging differ substantially from the traditional ISR observation looking up through the atmosphere at objects of small angular extend (long range). Values of qₒ may vary an order of magnitude over the course of a day.

Applicants apply the current state of the art in image processing to solve the anisoplanatic imaging problem. The argument is as follows: Consider a 3 m FOV at 30 km (corresponding to the group of humans close together). Then the width of the field is 3 m/30 km=100 μrad. The isoplanatic angle is 15 grad. This implies that the image acquired by a MTS-B gimbal will be broken up into approximately 6×6=36 separate images, each with its own unique wavefront. These distinct wavefronts will interfere among themselves, resulting in image warping, similar to the “funhouse” mirror effect. Each 50 cm portion of the image will move against the neighboring element, producing a very distorted, warped imaged. This effect severely degrades image resolution, since a single portion of a face of one target will interfere with the neighboring part of the image, perhaps an adjacent face or background.

### Lucky Regions

Fortunately, if a sequence of short-exposure (10 msec) images are recorded in sequence, a finite fraction of the images will capture “lucky regions” of momentarily large isoplanatic angle portions of the image, which produce a diffraction-limited glimpse of that portion of the image. Applicants have verified this effect with actual experiments in a much different imaging scenario (faces and similar targets at 1 km range, for sniper target verification). Thus, if Applicants can record a series of short exposures, and keep track of the lucky regions, a pristine image can be reconstructed, as Applicants actual experiments have shown. However, the approximate 30 lucky regions must be “dewarped”, since they interfere with each other during the sequence of exposures. Thus, the key is to locate lucky sub-regions of the image for each frame, and then use software to register the regions with respect to each other.

For turbulence in the near-field of the object, a unique physical effect occurs. Since most of the turbulence is located within 1 km of the ground, Applicants consider the bending of light rays from a single phase screen at 1 km range from the target. The various diverging point sources emanating from the target which extend beyond the normal diffraction-limited ray path (outside the conventional imaging cone of rays) can be bent by the phase screen layer, in some cases as turbulence evolves focused inward toward the MTS-B receiver. In this case, the rays have sampled an effective larger “lens”, induced by the atmospheric layer. The probability for this occurrence is finite, on the order of 10% of the time, as Applicants have shown through experimental data. Thus, rays from the target normally outside the diffraction-limited cone of rays can be intercepted by the telescope. These rays contain valuable information, since they behave in the imaging plane as if they were gathered by a much larger (a factor of two) mirror, hence producing resolution equivalent to a much larger gimbal imaging system. Applicants exploit this effect, capturing regions of the image which are super-resolved (3 cm resolution at R=30). The imaging processing software detects, dewarps, and registers these portions of the image, resulting in a super-resolved face or license plate image.

Applicants have examined the basic anisoplanatic imaging physics for a typical UAV observation. Fundamentally, the super-resolution method works because rays that are normally diffracted outside of the aperture of a telescope system can be bent back into the aperture by a distant phase perturbation. From a Fourier optics perspective, high spatial-frequency components in the object are shifted by the phase aberration to a frequency within the diffraction limited cutoff of the telescope system; object spatial frequencies outside of the diffraction limit can thus be recorded by the optical system, and super-resolved image reconstruction is possible. Charnotskii et al ((JOSA A Vol. 7 No 8 Aug. 1990) have presented a theoretical framework (and supporting laboratory measurements) for understanding this effect.

Although Charnotskii's work lays out the mathematical principles and presents experimental results, the theoretical exposition treats only very simple phase screens; this significantly simplifies the mathematics and allows demonstration of the principle, but limits the utility of the mathematical model for applications where higher order phase terms are needed. Applicants have expanded Charnotiskii's work, considering a screen comprised of Zernike polynomials, and have derived a closed form expression for shifts due to a phase screen that includes the focus and astigmatism terms (Z₄, Z₅, Z₆). The resulting model is general and predicts the spatial-frequency shift of a particular object frequency given an imaging geometry and a set of Zernike coefficients. A specific object frequency (represented by a amplitude grating) is selected and a phase screen generated. The generalized anisoplanatic transfer function representing propagation is applied, resulting in a shift in both the magnitude and the frequency of the object frequency. Depending on the nature of the phase screen, the frequency is either shifted to higher, or lower frequencies, and therefore may or may not be useful.

The nature of this frequency shift holds the key to the super-resolution phenomena. Optical systems are generally characterized by their ability to pass spatial information through a frequency transfer function, known as the Modulation Transfer Function (MTF). These transfer functions show that low frequency (i.e. no fine detail) information is passed with no attenuation, but as the level of detail becomes finer, the information is attenuated until a cutoff is reached at the diffraction limit. In this transfer function the independent variable is spatial frequency normalized to the diffraction limit, and the dependent variable is the normalized magnitude of a given level of detail.

In the typical imaging case a spatial frequency below cutoff is attenuated by the MTF. Similarly, a frequency beyond cutoff is completely attenuated. The super-resolution effect occurs because a distant phase screen (and propagation) shifts this frequency from outside the cutoff to inside the cutoff. This frequency is now resolvable by the optical system.

Applicants model is generally applicable to any Zernike phase screen, but can easily be applied specifically to the problem of imaging through the atmosphere. Noll's (JOSA Vol. 66 No. 3 Mar. 1976) well-known results provide a link between atmospheric phase and Zernike polynomials; this formalism allows Applicants to compute the statistics of each Zernike coefficient for a given atmospheric turbulence strength, and then use these statistics to generate Zernike realizations of the associated atmospheric phase.

Because of the random nature of the atmospheric phase screens, Applicants use a Monte Carlo analysis to examine the imaging problem. The procedure is simply to generate a large number of random screens for each observation geometry and object spatial frequency, compute the associated frequency shift that occurs during propagation, and count the number of shifts within the image frequency cutoff. With a large number of realizations, Applicants then compute an effective “probability of super-resolution”, which serves as a metric for the likelihood of performing effective image reconstruction. This process can be easily illustrated through a sample run (corresponding to the UAV observing case with a slant range of 40 km).

To evaluate the strength of the super-resolving effect, Applicants have computed the probability of resolved frequency shifts for several (normalized) object frequencies for the UAV observing case. The independent variable is slant range, each unique value of which produces a unique set of observing and turbulence parameters. The dependent variable is the probability that an object frequency of n times the diffraction limit is shifted to an image frequency less than the diffraction limit (and therefore be observable by the telescope system). Again probability here is defined in the Monte Carlo sense, where for each range 20,000 phase screens have been generated and the associated frequency shifts computed.

At short range D/r₀ is small enough that frequency shifts are unlikely to occur; as the range increases r₀ becomes smaller and the phase screen shifts relatively closer to the aperture plane, and these probabilities become substantial. It is also instructive to plot super-resolution probabilities as a function of the normalized object frequency for three bracketing slant ranges.

Any shifts below p=1 are not super-resolving per-se, since they represents object frequencies within the diffraction limit; however, the frequency shifts associated with transmission through the atmosphere do allow for resolution (with some probability) of frequencies between the diffraction and seeing limits (still a net benefit). Also, for p<½ the probability of resolving the object frequency p is unity. This again is expected since for our observing case D/r₀ is on the order of 2, and the system should always be capable of resolving frequencies below 1/r₀. Finally, for object frequencies outside of the diffraction limit (p>1), shifts to resolved frequencies (q<1) occur with non-zero probability well beyond the diffraction limit; even for objects of twice the diffraction limit the probability of super-resolved information is greater than 0.1. Again the longer ranges provide better performance through a more favorable phase screen position and D/r₀.

Although the present invention has been described above in terms of specific preferred embodiments persons skilled in this art will recognize that many changes and variations are possible without deviation from the basic invention. Many different types of telescopes and cameras can be utilized. Imaging is not limited to visible light. The systems could be mounted on vehicles other than UAV's. Various addition components could be added to provide additional automation to the system and to display positions information. Accordingly, the scope of the invention should be determined by the appended claims and their legal equivalents.

We claim:

1. A process for converting a series of short-exposure, digital telescopic small-FOV zoom images to, high-resolution images within a fraction of a second, said process comprising:
A) recording a series of short exposure images of the field of view,
B) removing turbulence effects by real time processing of the series of images to improve the resolution of the images to approximately diffraction limited images,
C) further improving the images utilizing a screen comprised of Zernike polynomials to improve the resolution of the images.

2. The process as in claim 1 wherein the images are improved to approximately double diffraction limited resolution.

3. The process as in claim 1 wherein a turbulent layer in the near-field of the object can acts as a lens, focusing rays ordinarily outside the diffraction-limited cone into the distorted image.

4. The process as in claim 1 wherein the field of view is imaged with a telescope on a UAV through strong turbulence, to obtain super-resolved imagery, at 2× the diffraction limit.

5. The process as in claim 4 wherein said telescope has an aperture of about D=30 cm and produces images that are equivalent in resolution to a telescope with D=60 cm looking through non-turbulent air.

6. An imaging system comprising:
A) a UAV
B) a telescopic system mounted on the UAV said telescopic system comprising:
a) a telescope defining an aperture adapted to rapidly image a field of view to produce a series of images at rates of at least ______ images per second
b) a computer processor adapted:
i) to process the images to improve resolution of the images to approximately diffraction limited resolution and
ii) to further process the images better than diffraction limited utilizing a screen comprised of Zernike polynomials.
